(19) United States
(12) Patent Application Publication
(10) Pub. No.: US 2003/0147713 A1
(43) Pub. Date: Aug. 7, 2003

(54) Router bit system

(76) Inventor: Tyler J. Dembicks, Raleigh, NC (US)

Correspondence Address: Akerman Senterfitt, Post Office Box 3188, West Palm Beach, FL, 33402-3188, US

(21) Appl. No.: 10/349,703

(22) Filed: Jan. 22, 2003

Related U.S. Application Data
(63) Continuation-in-part of application No. 10/056,840, filed on Jan. 25, 2002.

(51) Int. Cl. B23C 5/26

(52) U.S. Cl. 409/182; 407/53

(57) ABSTRACT

A router bit system and method. The system includes at least one shaping body having at least one cutting blade and at least one shank, at least one guide bearing and a fastener for detachably coupling the guide bearing to said shaping body in which the shank includes at least one substantially flat surface for receiving a gripping device. The substantially flat surfaces of the shank can include a plurality of raised ridges for providing a slip-resistant gripping surface. In addition, at least a portion of the substantially flat surface of the shank can include a protective material. The cutting blades of the shaping body can remove a predetermined amount of material from a workpiece in which the predetermined amount of the material removed can be partially based upon a radius of the guide bearing.

### CROSS-REFERENCE TO RELATED APPLICATIONS

This is a continuation-in-part of application Ser. No. 10/056,840, filed Jan. 25, 2002.

### BACKGROUND

1. Technical Field

The present invention relates generally to woodworking equipment, and more particularly to router bits used to shape or trim sections of wood or other materials.

2. Description of Related Art

Currently, many craftsmen use routers to trim or shape to a desired configuration certain materials such as blocks of wood. For example, a router can be used to sculpt baseboards or crown moldings. A router typically contains an opening for receiving and securing a router bit and includes a motor for rotating the router bit. In addition, a router can receive, secure and rotate a wide variety of router bits, which permits a user to create a large number of designs.

Router bits typically contain a substantially circular guide bearing, which can be used to enable a user to perform a substantially uniform cut as a block of wood is moved along the router bit. In addition, the radius of the guide bearing can help determine the depth at which the cut will be implemented. Thus, a user can replace a particular guide bearing with a large or smaller guide bearing to create a deeper or more shallow cut. To replace a guide bearing, the user usually grasps the shank of the router bit with a grasping device such as a pair of pliers or a wrench, a step that can stabilize the router bit during the replacement procedure. Unfortunately, this stabilizing step can damage the shank of the router bit thereby reducing its effectiveness. Moreover, a sudden, unexpected movement of the cutting blades of the router bit may occur if the grasping device slips, which can result in serious injury to the user. Thus, what is needed in the art is a router bit that overcomes the limitations of the prior art without significantly increasing costs or design complexity.

### BRIEF DESCRIPTION OF THE DRAWINGS

FIG. 1 is a perspective view of a router bit in accordance with the inventive arrangements.

FIG. 2 is a partial sectional view of the router bit of FIG. 1.

FIG. 3 is a frontal view of a shank of a router bit in accordance with the inventive arrangements.

FIG. 4 is a side view of a shank of a router bit in accordance with the inventive arrangements.

FIG. 5 is a perspective view of an alternative embodiment of the invention having a square end.

FIG. 6 is a perspective view of an alternative embodiment of the invention having a hexagonal end.

FIG. 7 is a perspective view of an alternative embodiment of the invention having a star-shaped end.

FIG. 8 is a perspective view of an alternative embodiment of the invention having a cavity at an end of the shank of the router bit of this invention.

FIG. 9 is an exploded view of a router bit system of this invention.

FIG. 10 is a collect of this invention.

### SUMMARY OF THE INVENTION

The present invention concerns a router bit system. The system includes at least one shaping body having at least one cutting blade and at least one shank, at least one guide bearing and a fastener for detachably coupling the guide bearing to the shaping body in which the shank includes at least one substantially flat surface for receiving a gripping device. In one arrangement, the substantially flat surface of the shank can include a plurality of raised ridges for providing a slip-resistant gripping surface.

At least a portion of the substantially flat surface of the shank can include a protective material. The protective material can be a cushioning material such as rubber or neoprene. In another arrangement, the cutting blades of the shaping body can remove a predetermined amount of material from a workpiece in which the predetermined amount of the material removed can be based in part on a radius of the guide bearing.

In one arrangement, the shank and the shaping body can be uniformly formed such that the shaping body and the shank can be a unitary component. In this particular embodiment, the shank and the shaping body can be formed from a single piece of metal. In another arrangement, the shank and the shaping body can be discrete components such that the shank can be permanently attached to the shaping body. Alternatively, the shank can be detachably coupled to the shaping body in which the router bit system can include a plurality of the shanks. In the arrangement concerning detachably coupled shanks, each shank can include at least one substantially flat surface having a predetermined surface area. In one particular arrangement, none of these predetermined surface areas are equal. Also, in another aspect, if the shanks can be detachably coupled to the shaping body, the router-bit system can include a plurality of shaping bodies. The cutting blades on each shaping body can have different configurations.

In other embodiments, the shanks of the router bit may have a section for receiving a gripping device that may be coupled to the ends of the shanks or at other locations on the shanks. The sections may have a section for receiving a gripping device to facilitate easy removal of the shanks. For instance, the shank may have a cross-section shaped as a rectangle, square, hexagonal, star or other shape. In another embodiment, the end of the shank may have a cavity for receiving a gripping device. The cavity may have any cross section enabling the gripping device to engage the walls of the cavity without slipping.

The invention also concerns a method of replacing a guide bearing of a router bit in which the router bit includes a fastener and a shaping body having at least one substantially flat surface in which the fastener detachably couples the guide bearing to the shaping body. The method includes the steps of: gripping the substantially flat surface of the shank with a gripping device; holding the shank substantially immobile; removing the fastener; replacing the guide bearing with a new guide bearing; and securing the new guide bearing to the shaping body with the fastener.

In one arrangement of the method, the substantially flat surface of the shank can include a plurality of raised ridges for providing a slip-resistant gripping surface. Additionally, at least a portion of the substantially flat surface of the shank can include a protective material. The protective material can be a cushioning material such as rubber or neoprene.

In another embodiment, the router bit may have a shank that has an end configured to be received by a collect. The collect may have a receiver sized and configured to prevent the shank from rotating relative to the collect. The end of the shank may have numerous configurations. The receiver may also include a protrusion that is capable of being received by the end of the shank.

### DETAILED DESCRIPTION OF THE PREFERRED EMBODIMENTS

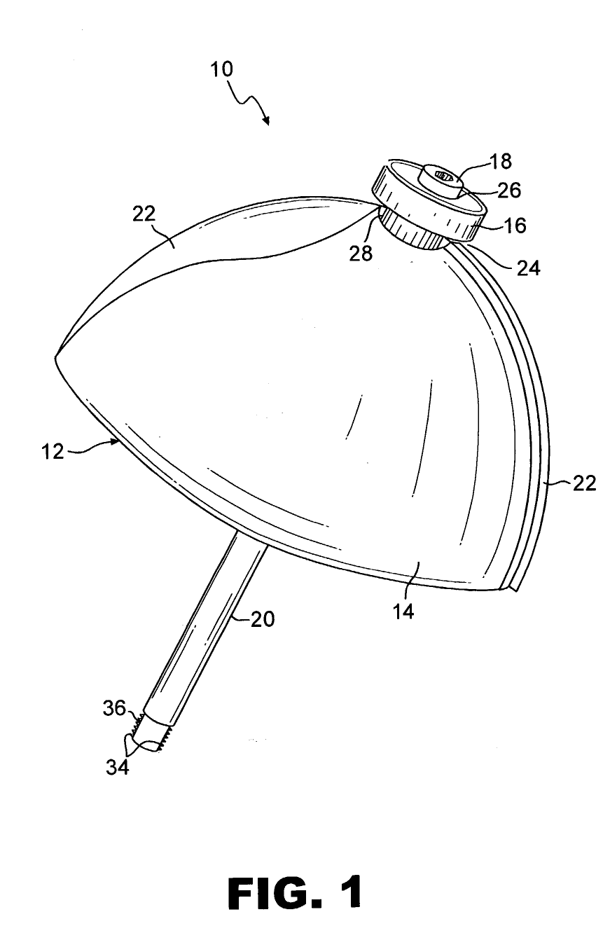

FIG. 1 illustrates a router bit system 10 according to the invention, which can be used to trim or shape certain objects to a desired configuration. As an example, the router bit system 10 can be used to trim blocks of wood or other materials. The system 10 can include a router bit 12, at least one shaping body 14, at least one guide bearing 16 and a fastener 18. The fastener 18 can be any suitable structure such as a screw. In one arrangement, the shaping body 14 can include at least one shank 20 and one or more cutting blades 22. The shaping body 14 and the shank 20 can be uniformly formed such that the shaping body 14 and the shank 20 are considered a unitary component, i.e., no assembly is required. For example, the shaping body 14 and the shank 20 can be formed from a single piece of metal.

Alternatively, the shaping body 14 and the shank 20 can be separate components such that the shank 20 can be either permanently attached or detachably coupled to the shaping body 20. In this embodiment, the shaping body 14 and the shank 20 can be formed from the same material or from different materials. If the shaping body 14 and the shank 20 are detachably coupled, any suitable mechanism can be used for detachably coupling these components. As an example, a spring-biased hitching mechanism can be employed, or the shank 20 can be threadably coupled to the shaping body 14.

The cutting blades 22 can be constructed of any suitable material, including a durable material such as, for example, carbide-tipped steel, to improve the life of the router bit 12. As shown in FIG. 1, the cutting blades 22 can follow the outline of the shaping body 14. It should be noted, however, that the configuration of the cutting blades 22 is not limited to the outline of the shaping body 14, as the cutting blades 22 can be any other suitable shape. In addition, the shaping body 14 is not limited to the particular design illustrated in FIG. 1, as the shaping body 14 can be any other suitable configuration.

In one arrangement, if the shaping body 14 and the shank 20 can be detachably coupled, then the router bit system can include a plurality of shaping bodies 14. The cutting blades 22 for each shaping body 14 can have a different configuration. As such, a wide variety of shaping bodies 14 each having cutting blades 22 of different configurations can be used with the router bit system 10. For purposes of the invention, a configuration of a cutting blade 22 can be the shape of the portion of the cutting blade 22 that can be used to come into contact with and trim the material being shaped. As an example, the configuration for the cutting blades 22 illustrated in FIG. 1 can be the edges of the cutting blades 22 running from an end 24 of the shaping body 14 to the bottom of the shaping body 14. It is understood, however, that the invention is not limited to this particular example, as the cutting blades 22 can have any other suitable configuration.

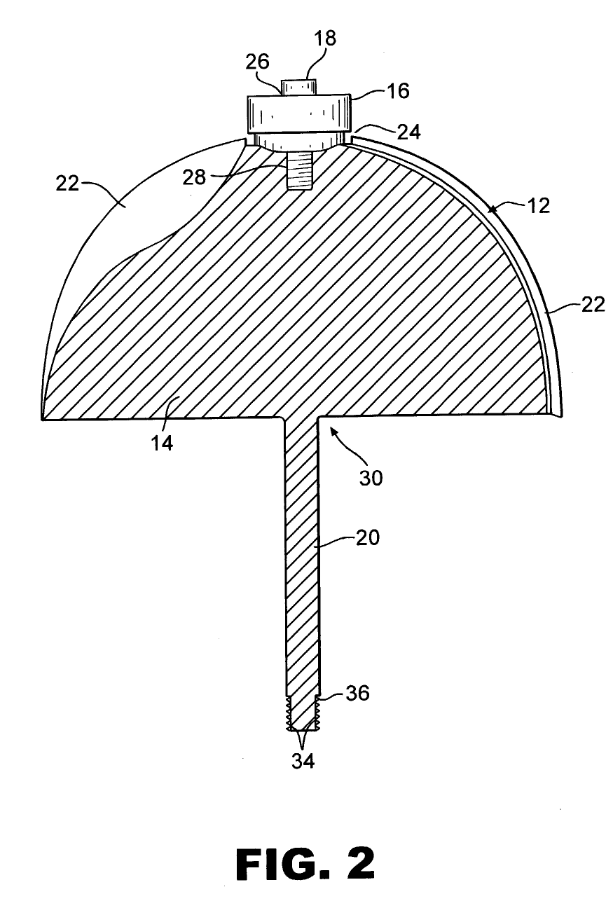

Referring to FIGS. 1 and 2, the guide bearing 16 can be attached to the end 24 of the shaping body 14. In one arrangement, the guide bearing 16 can be substantially circular and can include an aperture 26 for receiving the fastener 18. The end 24 of the shaping body 14 can also include a threaded aperture 28 for receiving the fastener 18 when the aperture 26 of the guide bearing 16 is substantially aligned with the threaded aperture 28. Thus, the fastener 18 can be used to detachably engage the guide bearing 16 to the shaping body 14. It is understood, however, that the guide bearing 16 can be attached to the shaping body 14 by any other suitable structure. Further, the fastener 18 can be designed so as to permit its engagement or removal with a wide variety of tools such as a conventional screw driver or an allen wrench.

In operation, the shank 20 can be inserted into a router (not shown), which can be used to rotate the router bit 12. As the router rotates the router bit 12, the cutting blades 22 on the shaping body 14 can remove a predetermined amount of material from a workpiece, such as a block of wood. The guide bearing 16 can move along a section of the workpiece not being trimmed. In one arrangement, because the workpiece and the guide bearing 16 can be pushed into contact with each other, the radius of the guide bearing 16 can help determine the amount of material removed from the workpiece. Thus, guide bearings 16 of different sizes can change the depth of the cut of the router bit 12. For example, for a deeper cut, a user can replace the current guide bearing 16 with another guide bearing 16 having a smaller radius. Conversely, for a more shallow cut, the user can replace the current guide bearing 16 with a guide bearing 16 having a larger radius. Guide bearings 16 may also wear out over time, which necessitates their replacement.

The shank 20 can include one or more substantially flat surfaces 34 for purposes of receiving a gripping structure of a gripping device (not shown) such as a pair of pliers, a wrench, a socket drive and a socket, a screw driver, an allen wrench, a TORX socket or wrench, or other device. The gripping device may be included in a router bit system. Each substantially flat surface 34 can have a predetermined surface area. This structure can permit the guide bearing 16 to be removed and replaced with another guide bearing 16 without damaging the shank 20.

For example, the gripping surfaces of the pincers of a pair of pliers can be placed against the substantially flat surfaces 34. After the pair of pliers is engaged, the shank 20 can be held substantially immobile, and the fastener 18 holding the guide bearing 16 in place can be removed. The guide bearing 16 then can be removed and replaced, and the fastener 18 can be tightened. It is understood that the term “substantially” means completely flat as well as slight or even moderate deviations therefrom, at least when discussed in connection with the substantially flat surfaces 34. Although FIGS. 1 and 2 show the substantially flat surfaces 34 as being located at one end of the shank 20, it must be noted that the invention is not limited in this regard. In fact, the substantially flat surfaces 34 can be located at any suitable position on the shank 20.

In another arrangement, if the shank 20 is capable of being detachably coupled to the shaping body 14, then shanks 20 having substantially flat surfaces 34 of varying surface areas can be used in conjunction with the shaping body. As an example, a shank 20 having substantially flat surfaces 34 with a first predetermined surface area can be replaced with a shank 20 having substantially flat surfaces 34 with a second predetermined surface area. The second predetermined surface area can be smaller or larger than the first predetermined surface area. Moreover, shanks 20 having substantially flat surfaces of varying geometric shapes can also be interchangeable with the shaping body 14.

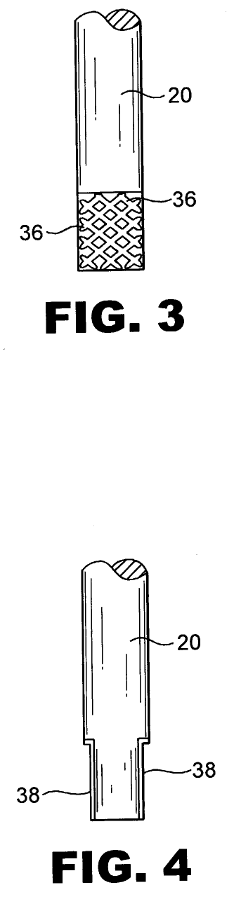

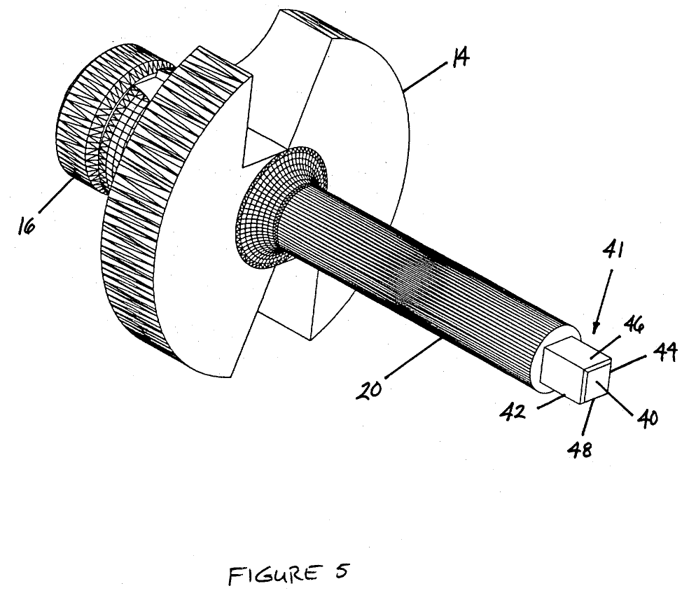

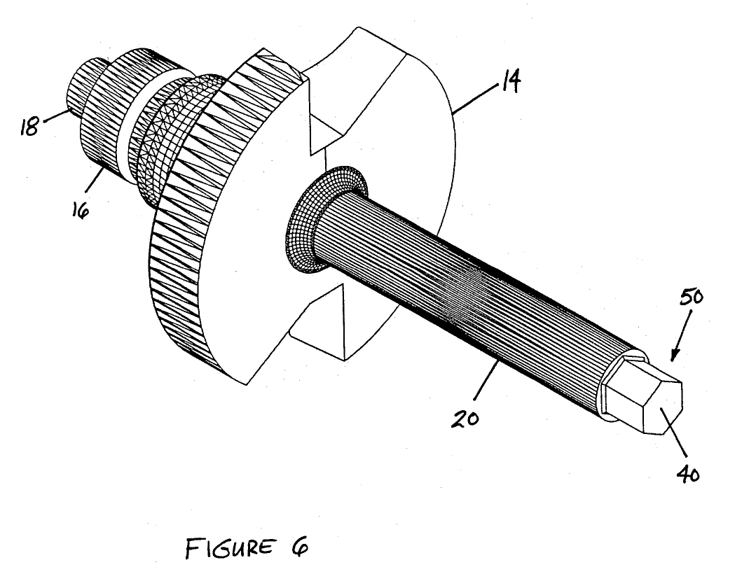

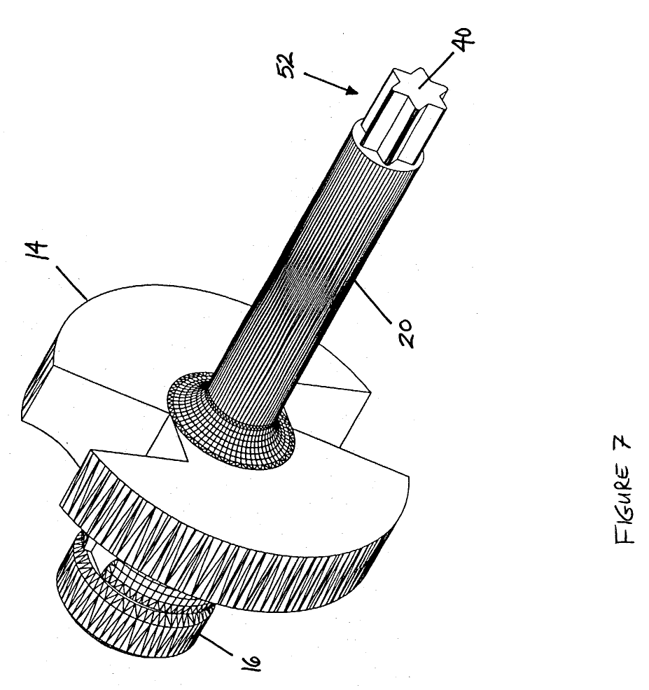

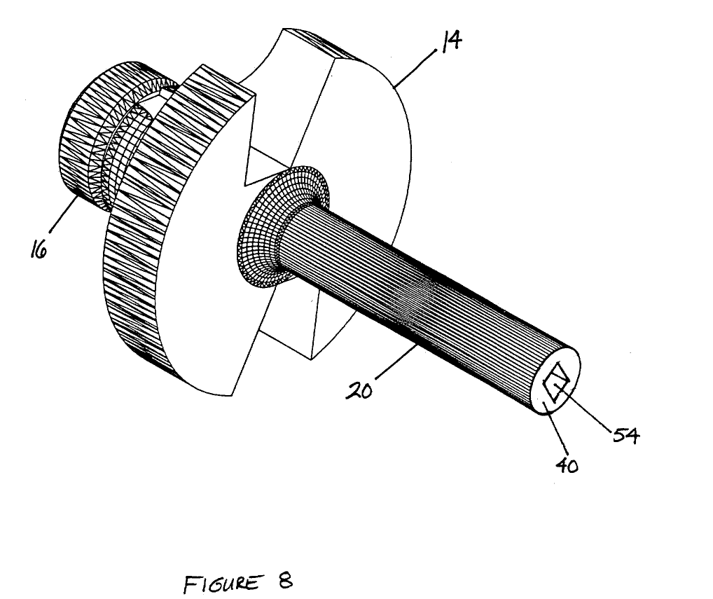

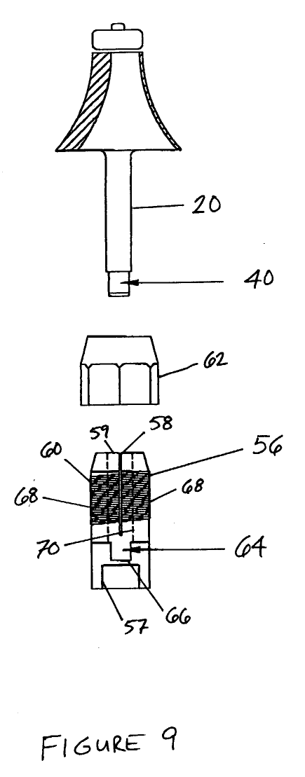

FIG. 3 is a frontal view of a shank 20 in accordance with the inventive arrangements. As illustrated in FIGS. 1, 2 and 3, the substantially flat surfaces 34 can also include a plurality of raised ridges 36 for providing a slip-resistant gripping surface. Although shown in FIG. 3 as employing a criss-cross design, the raised edges 36 can be any other suitable pattern. In another arrangement and as shown in FIG. 4, at least a portion of the substantially flat surfaces 34 of the shank 20 can include a protective material 38 for further protecting the shank 20 from damage caused by the gripping structure of the gripping device. In one arrangement, the protective material 38 can be a cushioning material. Examples of suitable cushioning material 38 can include rubber or neoprene.

In another embodiment, as shown in FIG. 5, shank 20 may include at least one section for receiving a gripping device. The section may be formed from a four-sided cross section 41 attached to an end 40 of shank 20, which is positioned generally opposite to the end of shank 20 that is attached to shaping body 14. Preferably, four-sided cross-section 41 is sized and configured to mate with conventional sized tools to facilitate removal of shank 20. Four-sided cross section 41 may be formed from a first side 42 and second side 44 that are generally parallel and opposite to each other, and a third side 46 and a fourth side 48 that are generally parallel and opposite to each other. Four-sided cross-section 41 may be a rectangle, a square, a trapezoid, a parallelogram or other four sided configuration. Four-sided cross section 41 may also be located on shank 20 at locations other than end 40. For instance, four-sided cross section 41 maybe located at any point along shank 20.

In another embodiment, as shown in FIG. 6, the section for receiving a gripping device may be a hexagonal cross section 50. Hexagonal cross section 50 may be sized to receive conventionally sized gripping devices, which may be sockets. Hexagonal cross section 50 may be attached to end 40 or to another portion of shank 20.

In another embodiment, as shown in FIG. 7, the section for receiving gripping devices may be a star-shaped cross section 52. Star-shaped cross section 52 may be attached to end 40 or to another location of shank 20. Star-shaped cross section 52 may be have five points, six points, as shown in FIG. 7, or more points. Preferably, star-shaped cross section 52 is sized and configured to receive a TORX socket or fitting.

In yet another embodiment, as shown in FIG. 8, the section for receiving gripping devices may be a cavity 54. Cavity 54 may have any shape capable of enabling a gripping device to engage the walls of the cavity. For instance, cavity 54 may have a cross section that is elliptical, or polygonal, such as, but not limited to star-shaped, triangular, rectangular, square, hexagonal, or other shape. The star-shaped configurations may have varying number of points, such as, but not limited to five or six pointed stars. Cavity 54 should have a depth sufficient to for a gripping device to engage shank 20. In one embodiment, cavity 54 may be, but is not limited to being, about ⅛ of an inch to about ¾ of an inch deep.

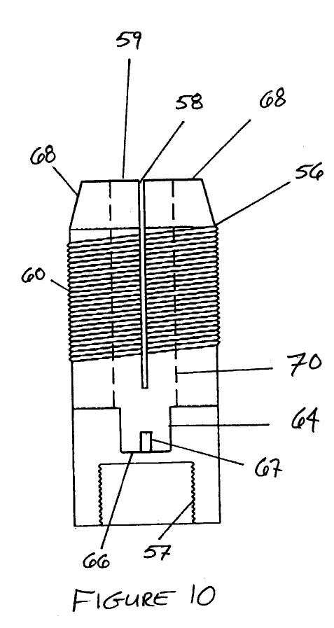

In another embodiment, router bit system 10 may be configured to be received in a collect 56, as shown in FIGS. 9 and 10. Collect 56 may also be referred to as a chuck and may be used to secure a router bit to a router. Collect 56 may include threads 57 for being threadably connected to a router. Collet 56 may have a generally cylindrical shaped body, or exterior shape, and include cavity 59 with one or more slots 58 positioned generally parallel to a longitudinal axis of the collect. Cavity 59 may be sized and configured to receive shank 20. An exterior surface 60 of collect 56 may have threads for receiving a nut 62. Nut 62 may have any appropriate size or configuration.

End 40 of shank 20 may be configured to fit securely into collect 56 and into receiver 64 at the bottom of the collect. End 40 may have any configuration enabling end 40 to engage receiver 64 and prevent shank 20 from rotating relative to receiver 64. In particular, end 40 may be configured to prevent any slipping between the interface between end 40 and receiver 64. For instance, end 40 may have a cross-section that is elliptical, polygonal, such as, but not limited to, a triangular, rectangular, hexagonal, star-shaped, or other shapes. End 40 may include a key configured to be received by a keyway in receiver 64, or vice versa. In one embodiment, end 40 may be configured as shown in FIGS. 5-7. In this embodiment, end 40 prevents shank 20 from rotating relative to collect 56 and enables a gripping device to be coupled to shank 20. In another embodiment, end 40 may be configured as shown in FIG. 8. In this embodiment, a base 66 of receiver 64 may have a protrusion 67 configured to mate with cavity 54. Protrusion 67 may have any cross section capable of preventing shank 20 from rotating relative to collect 56. In yet another embodiment, end 40 may have cavity 54 and the outside surface of end 40 may be configured as shown in FIGS. 5-7 or in other manners.

Shank 20 may be held securely in collect 56 by first positioning nut 62 on shank 20. Shank 20 may then be inserted into collect 56. End 40 of shank 20 may then be rotated until end 40 seats into base 66 of receiver 64. The configuration of end 40 may mate with the configuration of base 66. Nut 62 is threaded onto collect 56 and tightened. As nut 62 is tightened, wings 68 of collect 56 flex inward and slots 58 are reduced in size. As nut 62 continues to be tightened onto collet 56, an inside surface 70 of the collet contacts shank 20 and prevents the shank from most movement relative to the collet.

While preferred embodiments of the invention have been illustrated and described, it will be clear the invention is not so limited. Numerous modifications, changes, substitutions and equivalents will occur to those skilled in the art without departing from the spirit and scope of the invention as described in the claims.

What is claimed is:

1. A router bit, comprising:
at least one shaping body having at least one cutting blade and at least one shank;
at least one guide bearing; and
a fastener for detachably coupling the guide bearing to the shaping body;
wherein the shank comprises at least one section for receiving a gripping device.

2. The router bit of claim 1, wherein the at least one section for receiving the at least one gripping device comprises a hexagonal cross section.

3. The router bit of claim 2, wherein the hexagonal cross section is positioned at a first end of the at least one shank, wherein the first end is generally opposite to the second end of the at least one shank that is attached to the at least one shaping body.

4. The router bit of claim 1, wherein the at least one section for receiving the at least one gripping device comprises a four-sided cross section.

5. The router bit of claim 4, wherein the four-sided cross section comprises a first and second side positioned generally parallel and opposite from each other and a third and fourth side positioned generally parallel and opposite from each other.

6. The router bit of claim 4, wherein the four-sided cross section is positioned at a first end of the at least one shank, wherein the first end is generally opposite to the second end of the at least one shank that is attached to the at least one shaping body.

7. The router bit of claim 1, wherein the at least one section for receiving the at least one gripping device comprises a star-shaped cross section.

8. The router bit of claim 7, wherein the star-shaped cross section is positioned at a first end of the at least one shank, wherein the first end is generally opposite to the second end of the at least one shank that is attached to the at least one shaping body.

9. The router bit of claim 7, wherein the star-shaped cross section comprises a five pointed star.

10. The router bit of claim 7, wherein the star-shaped cross section comprises a six pointed star.

11. The router bit of claim 1, wherein the at least one section for receiving the at least one gripping device comprises a cavity for receiving the gripping device.

12. The router bit of claim 11, wherein the cavity is capable of receiving an allen wrench.

13. The router bit of claim 11, wherein the cavity is capable of receiving a five pointed wrench.

14. The router bit of claim 11, wherein the cavity is capable of receiving a six pointed wrench.

15. A router bit system, comprising:
at least one shaping body having at least one cutting blade and at least one shank comprising at least one section for receiving a gripping device; and
the at least one gripping device for gripping the shank.

16. The router bit system of claim 15, wherein the at least one section for receiving the at least one gripping device comprises a hexagonal cross section.

17. The router bit system of claim 15, wherein the at least one section for receiving the at least one gripping device comprises a four-sided cross section.

18. The router bit system of claim 17, wherein the four-sided cross section comprises a first and second side positioned generally parallel and opposite from each other and a third and fourth side positioned generally parallel and opposite from each other.

19. The router bit system of claim 15, wherein the at least one section for receiving the at least one gripping device comprises a star-shaped cross section.

20. The router bit system of claim 1, wherein the at least one section for receiving a gripping device comprises a cavity for receiving the at least one gripping device.

21. A router bit system, comprising:
at least one shaping body having at least one cutting blade and at least one shank;
wherein the shank has an end configured to be coupled to a collet so that the shank is fixed relative to the collet.

22. The router bit system of claim 21, wherein the end of the shank comprises a elliptical shaped cross section.

23. The router bit system of claim 21, wherein the end of the shank comprises a polygonal shaped cross section.

24. The router bit system of claim 23, wherein the end of the shank comprises a rectangular shaped cross section.

25. The router bit system of claim 24, wherein the end of the shank comprises a square shaped cross section.

26. The router bit system of claim 23, wherein the end of the shank comprises a star-shaped cross section.

27. The router bit system of claim 23, wherein the end of the shank comprises a cavity.

28. A collet for use with a router, comprising:
a body configured to be coupled to a router and having a cavity configured to receive a shank of a router bit; and
a receiver positioned in a bottom of the cavity for receiving an end of the shank of the router bit.

29. The collet of claim 28, wherein the receiver is configured to receive the end of the shank of the router bit wherein the end has a hexagonal cross section.

30. The collet of claim 28, wherein the receiver is configured to receive the end of the shank of the router bit wherein the end has a rectangular cross section.

31. The collet of claim 28, wherein the receiver is configured to receive the end of the shank of the router bit wherein the end has a square cross section.

32. The collet of claim 28, wherein the receiver is configured to receive the end of the shank of the router bit wherein the end has a star-shaped cross section.

33. The collet of claim 28, further comprising a protrusion coupled to the receiver.

34. The collet of claim 33, wherein the protrusion has a triangular cross-section.

35. The collet of claim 33, wherein the protrusion has a rectangular cross-section.

36. The collet of claim 33, wherein the protrusion has a square cross-section.

37. The collet of claim 33, wherein the protrusion has a hexagonal cross-section.

38. The collet of claim 33, wherein the protrusion has a star-shaped cross-section.
